(19) United States
(12) Patent Application Publication
(10) Pub. No.: US 2005/0244628 A1
(43) Pub. Date: Nov. 3, 2005

(54) Soft articles and method

(76) Inventors: Robert L. Turek, San Diego, CA (US); Dennis J. Fabian, Fallbrook, CA (US)

Correspondence Address: WILLIAM C. CAHILL, 155 PARK ONE, 2141 E. HIGHLAND AVENUE, PHOENIX, AZ, 85016, US

(21) Appl. No.: 10/917,611

(22) Filed: Aug. 13, 2004

Related U.S. Application Data
(60) Provisional application No. 60/565,977, filed on Apr. 28, 2004.

(51) Int. Cl. B32B 3/26

(52) U.S. Cl. 428/318.4; 428/318.6; 428/319.3; 428/319.7

(57) ABSTRACT

A soft article (2) for use in bathtubs, showers and other bathroom fixtures is manufactured by applying to a prepared mold (10) first, a primary coating (3) comprising one or more sprayed-on layers, which acts as a finish and provides a flexible skin structure, and subsequently applying a secondary coating comprising a sprayed-on layer of flexible foam (8) atop the primary coating. If the soft article is to be a liner, it is separated from the mold once the layer of flexible foam dries. For a new installation or for a stand-alone soft article such as a bath, a rigid structural layer (9) of structural urethane polyurea or structural polyurethane, which may or may not include chopped fiberglass, is then applied onto the foam layer. The soft article is then separated from the mold, and reinforcing pieces and gussets are then encapsulated into the rigid structural layer.

### CROSS-REFERENCE TO RELATED APPLICATION

The present application is related to, and claims priority of, a U.S. provisional application entitled “SOFT ARTICLES AND METHOD”, filed Apr. 28, 2004, and accorded Ser. No. 60/565,977, which application is assigned to the present assignee, and which is hereby fully incorporated herein by reference.

### BACKGROUND OF THE INVENTION

1. Field of the Invention

This invention relates to soft articles and their method of manufacture, and in particular to such articles for use in bathroom fixtures.

2. Description of the Related Art

Conventional bathtubs and showers are generally constructed of cast iron covered with porcelain, painted or gel coated fiberglass, painted metal, or the like, and made as a completed unit for installation and attachment to plumbing including a water source and a drain.

Slip and fall accidents occurring in bathtubs and showers have led to various efforts to make these devices safer, including providing bathroom articles that are cushioned. Examples of such cushioned articles can be found in U.S. Pat. Nos. 4,289,717 and 6,030,560 (“the 560 patent”).

The '560 patent describes making a cushioned article, which may be a bathroom article having a laminar structure, that involves separately forming a base and a top form that is coated with a flexible skin on the bottom side, then injecting a foam material into the pre-formed cavity between a male and a female mold. Such process is highly time consuming, resulting in high labor and production costs, with a low yield rate.

The '560 patent describes a method of making a cushioned article by applying successive coatings onto a form by a two-part mold resin injection process. A fiberglass-reinforced, polyester resin base is fabricated by a two-part mold injection process. A composite, flexible polymeric skin is fabricated in two steps. In the first step, a layer of resinous material is applied to a form that has a configuration complementary to the configuration of the base. A second layer of relatively dense, flexible skin foam is applied to the first layer while the first layer is still on the form. The base and the top form are assembled so that a cavity is defined between the base and top. A flexible cellular foam is injected into the cavity.

Insulation technology utilizes spray-in foam. However, the foam utilized for insulation is rigid and somewhat brittle, and would not be the type used for making soft or cushioned articles.

Accordingly, it is an object of the present invention to provide an efficient and quick method of producing a cushioned or soft article.

It is another object of the present invention to provide such method that can be utilized for making bathroom fixture articles having a laminar surface.

These and other objects of the present invention will become more apparent to those skilled in the art as the description of the present invention proceeds.

### SUMMARY OF THE INVENTION

Briefly described, and in accordance with a preferred embodiment thereof, the present invention relates to a method of manufacturing a soft article, which includes the following steps. a) Apply a primary coating to a mold. The primary coating includes one or more sprayed-on layers. The primary coating further provides a finish and a flexible skin structure to the soft article. b) Apply a secondary coating that includes a sprayed-on layer of a flexible cushioning foam atop the primary coating. The primary and secondary coating bond to form an integral soft article. c) Remove the soft article from the mold.

The present invention also relates to a soft article that includes a first finish layer, a second flexible skin layer that is disposed on the first finish layer, and a third foam layer that is disposed on the second flexible skin layer. The first finish layer includes ULTRACHROME 452™. The second flexible skin layer includes ULTRATHANE 5270™. The third foam layer includes ULTRAFOAM EC 28026™.

The present invention further relates to a soft bathroom fixture that includes a single finish and flexible skin layer, and a foam layer disposed on the single finish and flexible skin layer. The single finish and flexible skin layer includes ULTRACHROME 3050™. The foam layer includes ULTRAFOAM EC 28026™.

The simple sprayed-on method in accordance with the invention greatly reduces labor and time of production, in comparison to the prior art method of injecting foam material into a pre-formed cavity.

### BRIEF DESCRIPTION OF THE DRAWINGS

FIG. 1A is a cross-sectional view of a liner for a bathtub, in accordance with a preferred embodiment of the present invention.

FIG. 1B is a cross-sectional view of a stand-alone bathtub, in accordance with a preferred embodiment of the present invention.

FIG. 2 is a flow chart for a method of manufacturing a soft article, such as the liner or bathtub of FIGS. 1A and 1B, in accordance with a preferred embodiment of the present invention.

FIG. 3 is a cross-sectional view of a soft bathtub article, in accordance with a first embodiment of the present invention, shown before detachment from a prepared mold.

FIG. 4 is a cross-sectional view of a soft bathtub article, in accordance with a second embodiment of the present invention, shown before detachment from a prepared mold.

### DETAILED DESCRIPTION OF THE PREFERRED EMBODIMENTS

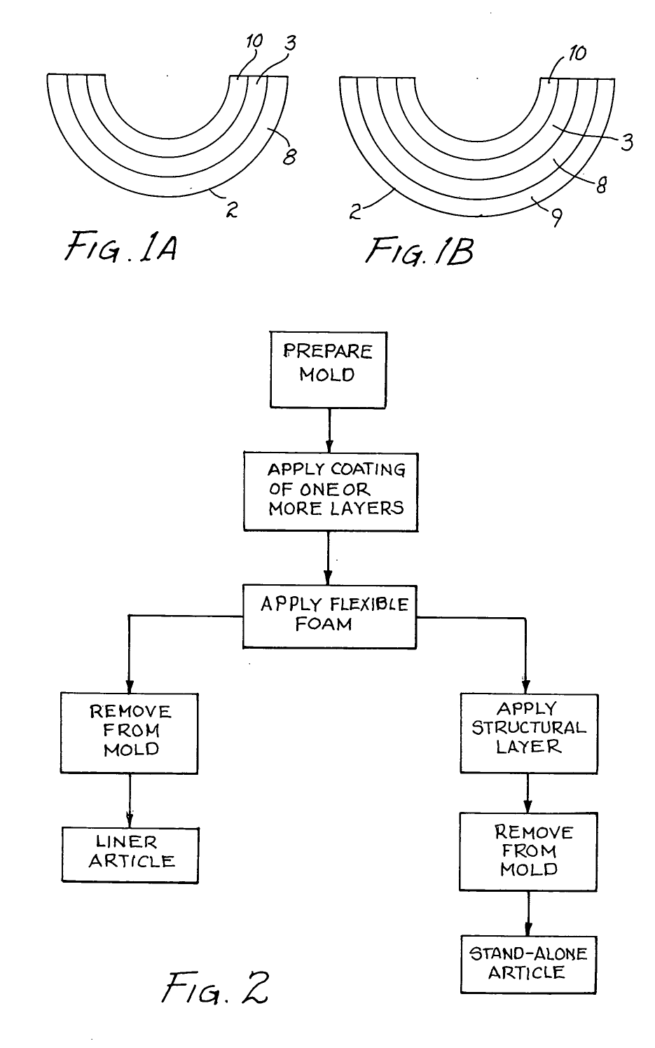

Referring to FIGS. 1A and 1B, a soft article 2 that is ideal for use in the manufacture of baths, showers, sinks and other bathroom fixtures, or as a retrofit liner for such fixtures, is manufactured according to a method comprising the steps of a) applying to a mold 10, which has the desired shape of the soft article 2 and which is prepared with a suitable releasing agent, a primary coating 3 comprising one or more sprayed-on layers, and b) applying a secondary coating atop the primary coating. The primary coating 3 acts as a finish and provides a flexible skin structure. The secondary coating comprises a sprayed-on flexible foam layer 8. The primary coating 3 and the secondary coating bond to form an integral soft article 2.

If the soft article 2 is to be a liner (see FIG. 1A), the article is separated from the mold 10 once the secondary coating, or foam layer 8, dries. For a new installation or for a stand-alone soft article 2 such as a bathtub (see FIG. 1B), a rigid structural layer 9 of a structural polyurethane, which may or may not include chopped fiberglass, is then applied onto the foam layer 8. Next, the soft article 2 is separated from the mold 10, and reinforcing pieces and gussets are then encapsulated into the rigid structural layer 9. The prepared mold 10 may be used many times for manufacturing a multiple number of articles 2.

FIG. 2 is a flow chart for a method of manufacturing a soft article, such as the liner for a bathtub of FIG. 1A or for the stand-alone bathtub of FIG. 1B.

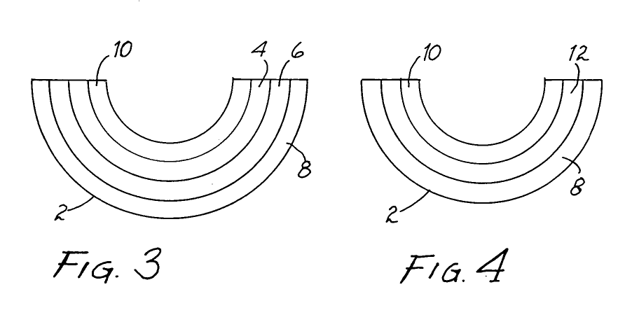

According to a first embodiment, as illustrated in FIG. 3, the primary coating 3 comprises a first finish layer 4 applied directly to the mold 10, and a second flexible skin layer 6 applied to the first finish layer 4. The foam layer 8 is applied atop the second flexible skin layer 6.

According to a second embodiment, as illustrated in FIG. 4, a single layer 12 that acts both as a finish layer and a flexible skin layer is applied directly to the mold 10, instead of the separate first finish layer 4 and second flexible skin layer 6 of the first embodiment. The foam layer 8 is then applied to the single layer 12.

The prepared mold 10 is made from a variety of different materials that are standard in the industry, among the preferred being fiberglass/polyester resin, or, for high production efficiency, aluminum filled epoxy or metal, which are more expensive but able to withstand more uses. Also, as is standard in the industry, such molds 10 typically include inner tubes or piping to enable cooling and heating of the mold 10 by circulating water throughout the piping. Preferably, a male mold 10 is used for a bathtub soft article 2 of the present invention, as shown in the figures, and the mold is heated throughout the manufacturing process. As is standard practice for polyurethane applications, the mold 10 and the manufacturing room should be kept at a low humidity and clean during the manufacturing process, and especially during application of the releasing agent and first finish layer 4, as dust, grease, and other dirt may degrade the quality of the finished product. Steps that may be taken to improve the condition of cleanliness in the manufacturing room may include filtering the air in the room, keeping the room door tightly closed, and having individuals who enter the room wear gloves and masks or respirators.

Prior to applying the first finish layer 4, a suitable releasing agent is applied to the heated mold 10. At this stage, the temperature of the mold 10 is between approximately 120° F. and 150° F. Although the temperature of the mold 10 may be kept at this temperature throughout the manufacturing process, it may be lowered to between approximately 65° F. and 120° F. when applying the coatings. The releasing agent is preferably a non-transferable mold release that is commercially available from ITW Devcon Futura Coatings (hereinafter referred to as Futura Coatings) of St. Louis, Mo., and identified as mold release 9910. The releasing agent is manually rubbed onto the surface of the mold 10 using a cotton or other type of cloth. Once the mold 10 is prepared with the releasing agent, it may be re-used, without having to reapply the releasing agent prior to each use. A single mold 10 is used for manufacturing from approximately one hundred to more than one thousand soft articles 2 depending on the mold material, and assuming the mold is handled with care and no sharp tools or instruments are used for cleaning.

In reference to FIG. 3, and in accordance with the first embodiment, the first finish layer 4 applied to the prepared mold 10 is a single-component sprayed-on layer, which is UV and color stable, is abrasion resistant and provides a glossy finish. The preferred material used for this layer is an aliphatic, water-based polyurethane. A commercially available material, and one that has been found appropriate for the first finish layer 4 is known by the brand name ULTRACHROME 452™, and available from Futura Coatings. This material is listed as having a tensile strength of 3000 psi, an elongation of 150%, a tear strength of 400 pli, and a hardness of seventy-eight (78), making it highly flexible and impact resistant. Additionally, this material is VOC compliant and is fast drying, making it especially suitable for the application of the present invention.

The first finish layer 4 is applied by spraying the first layer material onto the mold 10 using a suitable pressure release system, such as a conventional pressure pot spray gun, a standard spray can or any airless spray equipment. Spray pressure is between approximately 40 psi and 100 psi. The thickness of the sprayed-on layer is at least approximately 2 mils, and preferably between approximately 2 mils and 5 mils, although the thickness may exceed Smils. Prior to application, a polyurethane colorant may be added to the wet material. The layer dries in approximately three (3) to five (5) minutes at room temperature, and faster at higher temperatures. It further produces a tough flexible surface that has excellent color retention, and is highly stain resistant, easy to clean, and releases easily from the mold 10, while forming a good bond with the second flexible skin layer 6. Because it is a single component and can be applied using any conventional and inexpensive system, as opposed to the application of a two-component system, described below, the color of the first finish layer 4, and hence the color of the finished soft article 2, may be easily changed with the manufacture of each successive soft article 2 using the same mold 10.

Once the first finish layer 4 has dried, the second flexible skin layer 6, which is a flexible structural in-mold layer, is sprayed onto the first finish layer. The preferred material used for the second flexible skin layer 6 is a two-component, solventless polyurethane elastomer, known as a 70-75 Shore A elastomer, listed by the brand name ULTRATHANE 5270™, and available from Futura Coatings. The ULTRATHANE 5270™ is particularly suitable for flexible foam applications, has a tear strength of 160 pli, an elongation of 250%, flexibility at temperatures below 30° F., and a high temperature resistance of 250° F. The ULTRATHANE 5270™ is fast curing, has outstanding abrasion resistance, a soft touch feel, and is VOC free.

The ULTRATHANE 5270™ comprises resin and isocianate, which are applied at a 50:50 ratio via a two-component spray system, and dries almost immediately after application. A polyurethane dual-component high-pressure spray machine is used to spray the two components, wherein the components are mixed just prior to spraying. Such dual-component spray machines are standard in the industry and are manufactured by Graco, Inc., of Minneapolis, Minn., Glas-Craft, Inc., of Indianapolis Ind., and Gusmer Corp., of Lakewood, N.J. The second flexible skin layer 6 is sprayed at a pressure of approximately between 1500 psi and 3000 psi, and is applied to a minimum thickness of approximately 20 mils, preferably between 50 mils and 100 mils, although the thickness may exceed 100 mils. The spraying equipment may be purged and cleaned after and prior to use with acetone, MEK, methylene chloride, or other approved solvents recommended by the equipment manufacturer.

Once the second flexible skin layer 6 has dried, the foam layer 8 of flexible cushioning foam is sprayed onto the second flexible skin layer. The preferred material used for the foam layer 8 is a two-component, solventless, microcellular polyurethane foam. A commercially available foam material suitable for use as the foam layer 8 is listed by the brand name ULTRAFOAM EC 28026™, and available from Futura Coatings. This foam has a density of 14-15 lb/ft, a tensile strength of 650-730 psi, an elongation of 110-160%, and a tear strength of 20-36 pli.

The two components of the ULTRAFOAM EC 28026™ are applied at a 50:50 ratio via a two-component spray system. The sprayed-on foam layer 8 dries almost immediately after application. Similar to the second flexible skin layer 6, a polyurethane plural-component high-pressure spray machine is used to spray the two components, wherein the components are mixed just prior to spraying. The foam layer 8 is sprayed at a pressure of approximately between 1500 psi and 3000 psi, and is applied to a minimum thickness of approximately 125 mils, preferably between 125 mils and 1000 mils, although the thickness may exceed 1000 mils.

If the soft article 2 is to be a retrofit liner, the article is completed at this point and is removed from the mold 10. The mold 10 is preferably cooled to room temperature to facilitate removal. The mold 10 can then be reused to manufacture another soft article 2. The releasing agent need not be reapplied to the mold 10 unless the mold is difficult to remove. Adhesive may be used to install the liner, depending on the shape of the liner and item into which it is installed. Such adhesive may be any conventional bonding cement that is preferably non-toxic and odorless.

If the finished soft article 2 is to be a stand-alone unit or new installation, a rigid structural layer 9 of structural polyurethane (FIG. 1B) is applied over foam layer 8. The rigid structural layer 9 is preferably a two-component, solventless, polyurethane/polyurea spray-on layer. A commercially available material suitable for the rigid structural layer 9 is listed by the brand name ULTRATHANE 5410™, and available from Futura Coatings. The ULTRATHANE 5410™ has a tensile strength of 4300 psi, an elongation factor of 30%, a flexibility modulus of 110,000 psi at 83° F., and a Shore D hardness of seventy-three (73). The rigid structural layer 9 may or may not include chopped fiberglass.

The two components of the ULTRATHANE 5410™ are applied at a 50:50 ratio via a two-component spray system. The rigid structural layer 9 dries almost immediately after application. Similar to the previous two-component layers, a polyurethane dual-component high-pressure spray machine is used to spray the two components, wherein the components are mixed just prior to spraying. The rigid structural layer 9 is sprayed at a pressure of approximately between 1500 psi and 3000 psi, and is applied to a minimum thickness of approximately 20 mils, preferably between 50 mils and 100 mils, although the thickness may exceed 100 mils. If fiberglass is to be used, it is either laid on top of the previous layer as the rigid structural layer 9 is sprayed-on, or is chopped and applied during spraying. The fiberglass used is preferably a short strand type of fiberglass that is standard in the industry. Again, the mold 10 is preferably cooled to room temperature prior to removal and can be reused. Prior to the removal from the mold 10, and if required, reinforcing pieces, gussets and accessories are encapsulated into the rigid structural layer 9, or the structural backup. In reference to FIG. 4, and in accordance with the second embodiment, the single layer 12 is an UV-stable and light-stable skin layer that may be applied directly to the mold 10 in place of the first finish layer 4 and the second flexible skin layer 6 of the first embodiment. The preferred material used for this layer is a solventless, aliphatic, two-component, spray-on polyurethane material. A suitable commercially available material is listed by the brand name ULTRACHROME 3050™, and available from Futura Coatings. This material has a tensile strength of 2500 psi, an elongation factor of 110%, a tear resistance of 230 pli, and a high temperature resistance of 250° F. The ULTRACHROME 3050™ has a fast cure time, excellent mark abrasion and tear resistance, and is VOC free.

The two components of the ULTRACHROME 3050™ are applied at a 50:50 ratio via a dual-component spray system. The single layer 12 dries almost immediately after application. Similar to with the previous two-component layers, a polyurethane plural-component high-pressure spray machine is used to spray the two components, wherein the components are mixed just prior to spraying. The single layer 12 is sprayed at a pressure of approximately between 1500 psi and 3000 psi, and is applied to a minimum thickness of approximately 20 mils, preferably between 50 mils and 100 mils, although the thickness may exceed 100 mils. A colorant may also be added prior to application. Because the dual-component spray machine used to apply the ULTRACHROME 3050 is far more intricate and expensive then the simple equipment used to apply the ULTRACHROME 452™, changing colors may be less practical with the ULTRACHROME 3050 because either a new spray machine would have to be used or the machine would have to be thoroughly cleansed, and depending on the amount of residue left, a darker colorant may have to be used.

Various modifications and changes may be made to the described embodiment by those skilled in the art without departing from the true spirit and scope of the invention as defined by the appended claims. For example, other fixtures such as sinks, shower enclosures, wall panels, counter tops, floor mats, spas, whirlpools, small swimming pools and hot tubs may be formed by the method of the present invention. The method is also useful in the production of safety or comfort articles such as interior components for vehicles, dashboards, children's play equipment, furniture and toys.

1. A method of manufacturing a soft article, comprising the steps of:
applying a primary coating to a mold, said primary coating comprising one or more sprayed-on layers, said primary coating further providing a finish and a flexible skin structure to said soft article;
applying a secondary coating comprising a sprayed-on layer of a flexible cushioning foam atop the primary coating, said primary and secondary coating bonding to form an integral soft article; and removing said soft article from said mold.

2. The method of claim 1, further comprising the step of applying a releasing agent to said mold, prior to applying said primary coating.

3. The method of claim 1 wherein said primary coating comprises a first finish layer applied to said mold and a second flexible skin layer applied atop said first finish layer, and wherein said secondary coating is applied atop said second flexible skin layer.

4. The method of claim 3, wherein said first finish layer is a single-component polyurethane.

5. The method of claim 3, wherein said first finish layer is water-based.

6. The method of claim 3, wherein said first finish layer is an aliphatic polyurethane.

7. The method of claim 3, wherein said first finish layer is a single component, aliphatic polyurethane.

8. The method of claim 3, wherein said first finish layer is ULTRACHROME 452™.

9. The method of claim 3, wherein said second flexible skin layer is a polyurethane elastomer.

10. The method of claim 3, wherein said second flexible skin layer is solventless.

11. The method of claim 3, wherein said second flexible skin layer is ULTRATHANE 5270™.

12. The method of claim 3, wherein said second flexible skin layer is a two-component polyurethane and is applied via a two-component spray system.

13. The method of claim 12, wherein said second flexible skin layer comprises resin and isocianate components.

14. The method of claim 1, wherein said primary coating comprises a colorant.

15. The method of claim 1, wherein said primary coating has a UV-stable finish.

16. The method of claim 1, wherein said primary coating has a light-stable finish.

17. The method of claim 1, wherein said primary coating comprises a single sprayed-on layer of ULTRACHROME 3050™.

18. The method of claim 1, wherein said secondary coating is solventless.

19. The method of claim 1, wherein said secondary coating is a microcellular polyurethane foam.

20. The method of claim 1, wherein said secondary coating is ULTRAFOAM EC 28026™.

21. The method of claim 1, wherein said secondary coating is a two-component polyurethane foam that is applied via a two-component spray system.

22. The method of claim 1, further comprising the step of applying a rigid structural layer atop said secondary coating prior to said step of removing said article from said mold.

23. The method of claim 22, wherein said rigid structural layer is applied by spraying.

24. The method of claim 22, wherein said rigid structural layer is solventless.

25. The method of claim 22, wherein said rigid structural layer is ULTRATHANE 5410™.

26. The method of claim 22, wherein said rigid structural layer includes fiberglass.

27. The method of claim 22, wherein said rigid structural layer comprises two components applied via a two-component spray system.

28. The method of claim 1, further comprising the step of heating said mold to above room temperature prior to said step of applying said primary coating.

29. A soft article, comprising:
a first finish layer including ULTRACHROME 452™;
a second flexible skin layer disposed on the first finish layer, the second flexible skin layer including ULTRATHANE 5270™; and
a third foam layer disposed on the second flexible skin layer, the third foam layer including ULTRAFOAM EC 28026™.

30. A soft bathroom fixture, comprising:
a single finish and flexible skin layer including ULTRACHROME 3050™; and
a foam layer disposed on the single finish and flexible skin layer, the foam layer including ULTRAFOAM EC 28026™.
